(19) United States
(12) Patent Application Publication
(10) Pub. No.: US 2024/0342537 A1
(43) Pub. Date: Oct. 17, 2024

(54) EXERCISE LOOP WITH ENHANCED FEATURES

(71) Applicants: AZIN EBRAHIM ZADEH, RENTON, WA (US); ALIREZA KHOSHGOFTARMONFARED, RENTON, WA (US)

(72) Inventors: AZIN EBRAHIM ZADEH, RENTON, WA (US); ALIREZA KHOSHGOFTARMONFARED, RENTON, WA (US)

(21) Appl. No.: 18/067,326

(22) Filed: Dec. 16, 2022

Related U.S. Application Data
(60) Provisional application No. 63/290,885, filed on Dec. 17, 2021.

(51) Int. Cl. A63B 21/055; B29C 45/03; B29L 29/00

(52) U.S. Cl. CPC A63B 21/0555; B29C 45/03; B29L 2029/00

(57) ABSTRACT

An exercise loop that can be used for isometric exercises comprising a loop of elastic materials that can have ridges and/or a curved or domed exterior surface which can help prevent the loop from rolling, slipping, and/or falling during use. The elastic materials can be comprised of thermoplastic elastomer, thermoplastic rubber, silicone, and/or an antimicrobial agent. The exercise loop can be between about two inches and seven inches. This greater width can also help prevent the loop from rolling which can bruise or otherwise damage the skin of a user. The loop and/or ridges can be hollow enclosing a cavity or solid. The cavity can be at least partially filled with a substance, such as gel, antimicrobial agent, and/or the like. The loop and/or ridges can be permeable, or the loop and/or ridges can be impermeable so as to keep a gel from coming out of the cavity.

### CROSS-REFERENCE TO RELATED APPLICATIONS

This application claims the benefit of provisional patent application Ser No. 63/290,885 filed 2021 Dec. 17 by Clark Edward Profit on behalf of the present inventors.

### TECHNICAL FIELD

The present specification relates to exercise equipment, more specifically to resistance loops.

### BACKGROUND

The following is a tabulation of some prior art that presently appears relevant:

U.S. Patents

| Pat. No. | Kind Code | Issue Date | Patentee |
|---|---|---|---|
| 20220387842 | A1 | 2021 Jun. 4 | Scott; Brian W. |
| 10,874,898 | B1 | 2020 Dec. 29 | Torres |
| D863470 | S1 | 2019 Oct. 15 | Zhong |
| 20190134446 | A1 | 2019 May 9 | DeYoung |
| 10,118,063 | B2 | 2018 Nov. 6 | DeYoung |
| 9,656,115 | B2 | 2017 May 23 | Young |
| 9,630,081 | B2 | 2017 Apr. 25 | Gillespie |
| 20160236026 | A1 | 2016 Aug. 18 | Hauptmann |
| 9,345,922 | B2 | 2016 May 24 | Allis0n et al. |
| 20150335937 | A1 | 2015 Nov. 26 | Park |
| 20150141217 | A1 | 2015 May 21 | Young |
| 20100292054 | A1 | 2010 Nov. 18 | Karpus et al. |
| 5,357,637 | A | 1994 Oct. 25 | Moore |
| 4,815,731 | A | 1989 Mar. 28 | Suarez et al. |
| 4,733,862 | A | 1988 May 29 | Miller |
| 3,819,177 | A | 1974 May 25 | Spiro |

Foreign Patent Documents

| Foreign | Country | Kind | | |
|---|---|---|---|---|
| Doc. Nr. | Code | Code | Pub. Dt | App or Patentee |
| 2016201103 | AU | A1 | 2015 May 31 | Santa, Joseph Luiz |

Resistance bands and loops are used by individuals looking to strengthen and tone their muscles in addition to the rehabilitation of patients with a wide variety of physical ailments. These bands generate resistance against body movement that can be used during exercise, during everyday activities, or during rehabilitation therapy. After an injury or surgical procedure, a patient under the care of physicians, physical therapists, and trainers is guided through a series of exercises using a wide variety of devices including resistance loops which offer differing degrees of resistance for any targeted muscle group.

Resistance loops are generally thin flat loops of elastic material such as rubber or latex. These loops often roll during a workout which requires the user to stop and adjust and unroll the loop. When the loop rolls it also becomes very narrow which can pinch and bruise the skin of the user especially for the elderly and people with sensitive skin. These resistance loops also slip, shift, and fall out of position on the body (for example when the loop is not under tension) which also requires the user to stop the workout and adjust the loop's position. This requires the user's focus to be on the placement and positioning of the loop instead of how they perform the exercise, and this distraction can lead to injuries.

Some have tried to solve this problem by using fabric instead of rubber as the material for the resistance loop. These loops tend not to roll, but the fabric loops are stiff, inflexible, and do not allow for as wide a range of motion as the loops made from rubber, or similar materials. Fabric loops are also not as durable and they lose elasticity with more usage, hence they have a higher rate of wear and tear which can lead to injuries when they tear and to a waste of resources when they need to be replaced.

There is accordingly a need for a resistance loop that is durable, elastic, and resistant to shifting and rolling.

### SUMMARY

Aspects disclosed herein comprise a resistance loop that resists rolling and slipping. In embodiments of the invention, an exercise band is provided comprising a loop of elastic material. The loop of elastic material may have a plurality of extensions extending from the interior surface to prevent the loop from folding on itself and to help prevent the loop from slipping on the user. The loop may alternatively or additionally have an exterior surface that is longer than the interior surface of the loop. The greater length of the exterior surface relative to the interior surface can give the exterior a shape such as a dome. The longer exterior surface may not be rounded but may have any other shape on the exterior surface.

The extensions may vertically traverse substantially all the interior surface, and may be perpendicular to the edge of the loop or may extend diagonally across the interior surface of the loop. The extensions may be straight, curved, or have a repeating pattern such as a sine or square wave shape. The extensions may be integral with the interior surface or may be adhered to the interior surface of the loop or attached to the interior surface of the loop.

In some embodiments, at least one of the raised extensions is hollow forming a cavity that may be filled with a substance or combination of substances. For example, the hollow cavity may be filled with a gel or polymer that may be repeatedly frozen or heated to allow the user to receive cold or heat therapy while using the band. The cavity may also be filled with a moisturizer or an antimicrobial agent that is able to be exuded from the cavity.

The elastic material may be comprised of at least one of thermoplastic elastomers, thermoplastic rubber, and silicone and have a width between about 5 centimeters and about 17 centimeters.

The objects of the invention may also be achieved by methods comprising producing an exercise loop by heating and mixing an elastic material in an extruder to a temperature, extruding the elastic material into a heated injection cylinder with 1) raised extensions on a surface of the loop, 2) a dome shaped surface of the loop or 3) raised extensions on one surface and a dome shaped surface on the opposite surface of the loop. The elastic material is injected into a heated centrifugal mold to form the loop. The extensions may be on the interior surface of the loop and may be generally vertical or generally horizontal across the vertical face of the band.

The injection cylinder may be shaped such that the raised extensions are substantially hollow and may be filled with a substance. The substance can include a gel, a lotion, or an antibiotic agent, or a substance that may be repeatedly frozen or heated to allow the user to receive cold or heat therapy while using the band/resistance loop.

The elastic material may be comprised of silicone, thermo-plastic rubber, thermoplastic elastomer (TPE), or some combination thereof. The width of the loop may be between 5 and 17 centimeters.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The term “such as” as used in this specification preceding an example or examples means including, but not limited to the recited example(s). The inventors are fully aware that they can be their own lexicographers if desired. The inventors expressly elect, as their own lexicographers, to use only the plain and ordinary meaning of terms in the specification and claims unless they clearly state otherwise and then further, expressly set forth the definition. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of molding a . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood regarding the following description, appended claims, and accompanying drawings where:

FIG. 1 is a perspective view of an exercise loop in accordance with one or more embodiments of the invention;

FIG. 2 is a semi-transparent perspective view of an exercise loop in accordance with one or more embodiments of the invention

FIG. 3 is a side view of an exercise loop in accordance with one or more embodiments of the invention;

FIG. 4 is a cross-sectional view of an exercise loop in accordance with one or more embodiments of the invention;

FIG. 5 is an isometric view of one embodiment of a ridge of an exercise loop in accordance with one or more embodiments of the invention;

FIG. 6 is examples of positions for the exercise loop in accordance with one or more embodiments of the invention.

### DETAILED DESCRIPTION

A user of exercise loops may have multiple interruptions to a workout session or other due to the loop rolling, slipping, sliding, and/or falling. The part of the body in contact with the loop can be called a workout surface. It is important for the loop to remain in full contact with a workout surface so as to prevent bruising, pinching and/or other irritations of the skin. This is especially relevant for users that are older or have sensitive skin. Implementations described herein help the loop remain in a desired position and allow a user to use the exercise loop without interruption to the workout session from the loop rolling, slipping, sliding and/or falling.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. The full scope of the inventions is not limited to the examples that are described below.

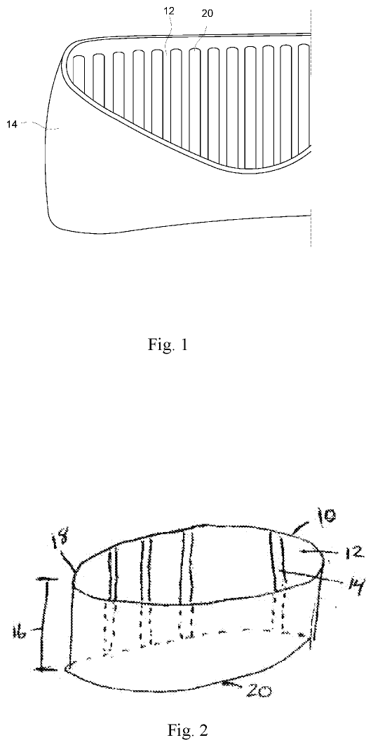

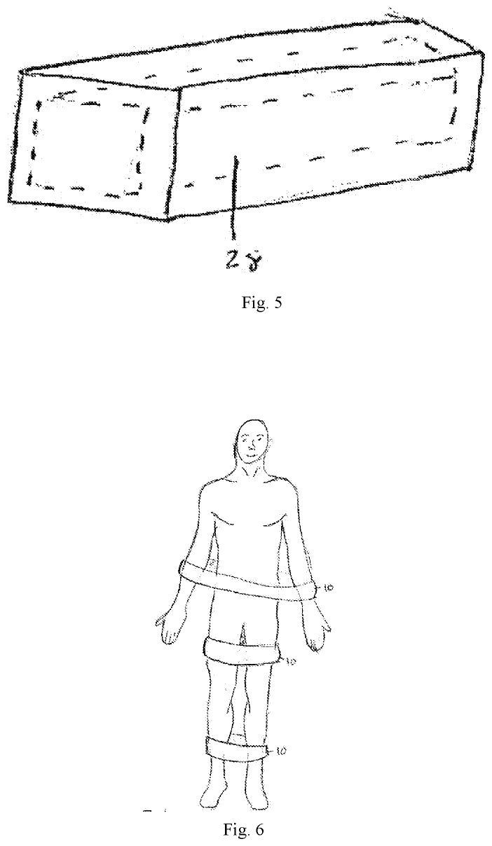

Referring to FIG. 1, an exercise loop 10 is provided substantially forming a loop. The band 10 need not be a full loop but may also include an end that can couple with the opposite end to form a loop. The band 10 is formed of an elastic material such as rubber, silicone, fabric, thermo-plastic rubber (TPR) and/or thermoplastic elastomers (TPE) or other suitable material or combination of materials. The band 10 has an interior surface 12 and an exterior surface 14, each extending from a top edge 16 to a bottom edge 18. The direct distance (i.e., not following the interior surface 12 or exterior surface 14) between the top edge 16 and the bottom edge 18 is the width 17 of the band 10. As shown in FIG. 5, the band 10 may be hollow enclosing a volume or may be a solid band.

The width 17 may be between about 5 centimeters and about 17 centimeters. In a particular embodiment, the width 17 is about 10 centimeters.

The interior surface 12 of the band 10 comprises a pattern of extensions 20 extending from the interior surface 12. In a particular embodiment, the pattern of extensions 20 is a plurality of ribs 22 that are roughly semi-cylindric in shape. The extensions 20 extend between about 2 mm to about 10 mm from the interior surface 12. The extensions 20 may traverse substantially all of the interior surface 12 as shown in FIG. 2 or may go only to the midband where it is offset from a pattern of extensions 20 on the other half of the band 10 as shown in FIG. 1. The interior surface 12 of the band 10 may also include a surface pattern to increase the grip or friction of the interior surface 12. The grip pattern 23 may be a plurality of geometric shapes or any other pattern that improves the grip of the interior surface.

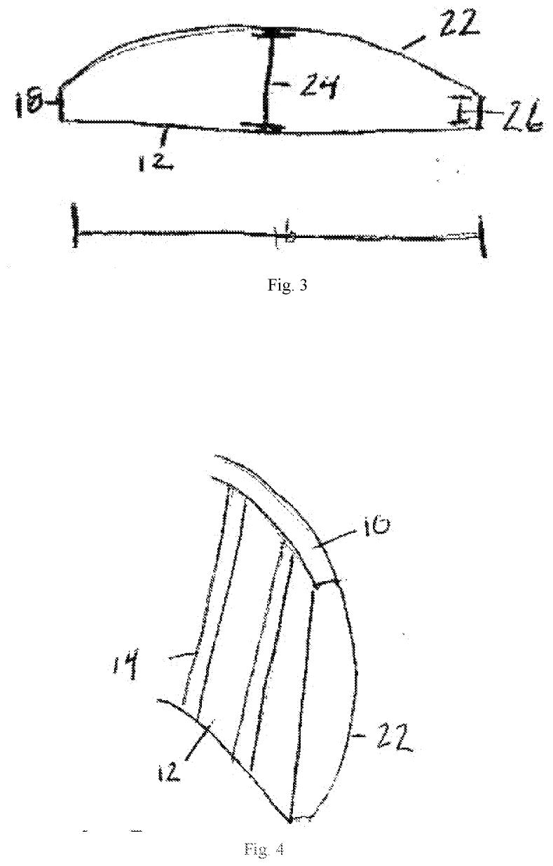

Referring to FIG. 1-3, the exercise loop 10 can be a generally cylindrical loop of elastic materials with an interior surface 12, and a loop width 16 which is defined by the distance from the loop top 18 and the loop bottom 20. The interior surface 12 can have at least one raised segment, or ridge 14. The length of the interior surface 12 will be approximately the length of the distance between the top edge 18 and the bottom edge 20 and the length of the exterior surface may be longer creating a bowed exterior surface 22 as shown in FIG. 3. The bowed or dome-shaped surface has a center depth 24 that is greater than an edge depth 26 and makes it more difficult for the band 10 to fold on itself or roll.

The loop 10 can be achieved by a variety of configurations, such as, a continuous loop, a seamless loop, a generally rectangular band wherein the band ends are connected to form a loop, and/or the like. The loop 10 can be solid, or hollow enclosing a volume.

The loop 10 can be comprised of any materials that provide an adequate range of motion and flexibility for isometric exercises, durable, and maintains its initial shape after being repeatedly stretched and relaxed, such as, fabric, latex, thermoplastic elastomers, thermoplastic rubber, silicone, or any combination of suitable materials. Preferably the loop is comprised of thermoplastic elastomer, thermoplastic rubber, and/or silicone as these materials have a high friction characteristic that aid them in maintaining their position on the body or workout surface. The loop remaining in position allows for a user to not focus on the loop position. For example, it allows a user to focus on the performance of an exercise and making sure the exercise is performed properly instead of readjusting the loop when it rolls, slips, slides, and/or falls. The elastic materials can additionally be comprised of an antimicrobial agent or material, to prevent or minimize bacterial growth on or within the loop.

The loop width 16 can be at least 5 centimeters (about 2 inches). Preferably the loop width is between 5 centimeters and 17 centimeters (between about 2 inches and 7 inches). The larger width of the loop will aid the loop in maintaining full contact with the workout surface and not rolling which can place added pressure on the workout surface and can cause bruising or other skin ailments.

The loop 10 interior surface 12 can have at least one ridge 14. Preferably the interior surface 12 will have a plurality of ridges 14. The ridge 14 can be integral with the band, or it can be connected to the band with any suitable means, such as, adhesive, hook and loop, and/or the like. In one or more embodiments the interior surface 12 has a plurality of ridges 14, wherein each ridge can be connected with the same means, different means, or any combination of same and different means. The ridge can extend across the width of the loop. In at least one embodiment a plurality of vertical ridges extends from the top of the loop 18 to the bottom of the loop 20. The ridges 14 can be vertical, horizontal, and/or any combinations of patterns such as a sine wave. The ridges 14 can extend to full width of the interior of the band 10 or can extend to the midband while the same or a different pattern is used on the other half of the interior of the band 10. The ridges 14 assist in preventing the loop 10 from rolling. The ridges 14 also help prevent the loop 10 from slipping or sliding. This prevents disruptions to an exercise session by removing the need to unroll and/or adjust the loop.

The ridge 14 can be solid, or hollow enclosing a cavity 28 [FIG. 5]. The cavity 28 can be empty (i.e., a vacuum or filled with air), or it can be at least partially filled with a substance, such as, gel, moisturizer, freezable gel, liquid, and/or the like. The ridges 14 can be permeable, allowing the substance, such as moisturizer to come into contact with the user's skin. The ridges 14 can be impermeable to prevent a freezable gel from coming into contact with the user's skin or workout surface. In at least one embodiment the loop 10 has a plurality of ridges 14, wherein each ridge of the plurality of ridges can be at least partially filled with the same, different, or any combination of same and different substances as that of other ridges. Additionally, each ridge 14 can be permeable, impermeable, or a combination of permeable and impermeable. The ridges 14 can be any shape [FIG. 5], such as, polygonal, diagonal, circular, triangular, rectangular, and/or the like. They can be of any size or direction. The ridges 14 can add to a user's comfort allowing for extended use of the loop and aid in treating skin irritations and ailments.

Referring now to FIG. 6, the loop 10 can be used in a variety of positions such as, above the knees, below the knees, below the elbows, and/or the like wherein the user can apply force inward and/or outward, hence training muscles by using the application and release of tensional forces. Similarly, the loop 10 can be attached to a pole or other stable pivot wherein the user can apply pressure outward hence training at least one muscle by using the application and release of tensional forces.

The exercise loop 10 can be manufactured through any appropriate means such as, injection molding, low pressure molding, structural foam molding, in-mold polymerization, multi-material coinjection, technical blow molding, rotational molding, shaped thermoforming, urethane casting and the like.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, the disclosed subject matter is in no way limited to a particular methodology, protocol, and/or reagent, etc., described herein. As such, various modifications, or changes to, or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. An exercise band comprising:
a loop of elastic material with an interior surface and an exterior surface, each surface having a distance between a top edge and a bottom edge, wherein the loop has at least one of:
a plurality of extensions extending from the interior surface, and
an exterior surface having a greater distance between the top edge and the bottom edge than the interior surface.

2. The loop of claim 1, wherein the extensions are vertically traverse substantially all the interior surfaces.

3. The loop of claim 1, wherein the extensions are at least one of:
substantially perpendicular to at least one edge of the interior surface;
essentially vertical or diagonal; and
integral with the interior surface.

4. The loop of claim 1, wherein at least one of the pluralities of raised extensions is hollow forming a cavity.

5. The loop of claim 4, wherein the cavity is at least partially filled with a substance.

6. The loop of claim 5, wherein the substance is at least one of a gel, a moisturizer, water, and an antimicrobial agent.

7. The loop of claim 1, wherein the exterior surface is dome shaped.

8. The loop of claim 1, wherein the elastic material is at least one of thermoplastic elastomers, thermoplastic rubber, and silicone.

9. The loop of claim 1, further comprising an antimicrobial agent.

10. The loop of claim 1, wherein the loop has a width between about 5 centimeters and about 17 centimeters.

11. A method of producing an exercise loop comprising the acts of:
heating and mixing an elastic material in an extruder to a temperature;
extruding the elastic material into a heated injection cylinder, wherein the cylinder has at least one of raised extensions on a surface of the loop, and a top edge and a bottom edge defining an exterior surface and an interior surface, wherein the distance between the top edge and the bottom edge on the exterior surface is greater than the distance between the top edge and the bottom edge on the interior surface;
injecting the elastic material into a heated centrifugal mold.

12. The method of claim 11, wherein the extensions are on the interior surface of the loop.

13. The method of claim 11, wherein the extensions are generally vertical or generally horizontal.

14. The method of claim 11, wherein the injection cylinder is shaped such that the raised extensions are substantially hollow.

15. The method of claim 14, further comprising the act of at least partially filling at least one of the pluralities of raised extensions with at least one of a gel, a lotion, and an antimicrobial agent.

16. The method of claim 11, wherein the elastic material is comprised of at least one of silicone, thermoplastic elastomer, and thermo-plastic rubber.

17. The method of claim 11, wherein the width of the loop is between 5 and 17 centimeters.

18. The method of claim 11, further comprising placing the exercise loop about the body of a patient with the at least one raised extension contacting the patient.

19. A method of exercising a person, the method comprising the acts of:
Providing a loop of elastic material with an interior surface and an exterior surface, each surface having a distance between a top edge and a bottom edge, wherein the loop has at least one of:
a plurality of raised extensions extending from the interior surface, and
an exterior surface having a greater distance between the top edge and the bottom edge than the interior surface;
placing the loop about the person with the interior surface contacting the person;
having the person move their body to increase the tension on the band.

20. The method of claim 19, further comprising the act of at least partially filling at least one of the pluralities of raised extensions with at least one of a gel, a lotion, and an antimicrobial agent.
